(19) United States
(12) Patent Application Publication
(10) Pub. No.: US 2018/0072883 A1
(43) Pub. Date: Mar. 15, 2018

(54) Composite Flame Retardant, Flame Retardant Resin Composition, Composite Metal Substrate, Flame Retardant Electronic Material and Flame Retardant Engineering Plastic

(71) Applicant: Guangdong Guangshan New Material Co., Ltd., Guangdong (CN)

(72) Inventor: Qingchong PAN, Guangdong (CN)

(21) Appl. No.: 15/635,484

(22) Filed: Jun. 28, 2017

(30) Foreign Application Priority Data
Sep. 14, 2016 (CN) 201610825034.3

(51) Int. Cl. C08L 63/00; C09K 21/06; C09K 21/14; C09K 21/12

(52) U.S. Cl. CPC C08L 63/00; C09K 21/06; C09K 21/14; C08L 2201/08; C08L 2205/025; C08L 2201/02; C09K 21/12

(57) ABSTRACT

The present invention provides a composite flame retardant, a flame retardant resin composition, a composite metal substrate, a flame retardant electronic material and a flame retardant engineering plastic, wherein the composite flame retardant comprises a bromine-containing flame retardant, as well as a sulfur-containing flame retardant and/or a phosphorus-containing flame retardant; said bromine-containing flame retardant is a bromine-containing phenol compound and epoxy resins thereof. The bromine-containing flame retardant has a synergistic effect on the flame retardant effect with the sulfur-containing flame retardant and/or the phosphorus-containing flame retardant, thereby enhancing the flame retardancy of the composite flame retardant and further enhancing the flame retardancy of the resin composition of the present invention. Therefore, the composite metal substrate, the flame retardant electronic material and the flame retardant engineering plastic prepared from the composite flame retardant or the flame retardant resin composition of the present invention have good flame retardancy, good mechanical properties and heat resistance.

### TECHNICAL FIELD

The present invention belongs to the field of flame retardant materials, and specifically relates to a composite flame retardant, a flame retardant resin composition, a composite metal substrate, a flame retardant electronic material and a flame retardant engineering plastic.

### BACKGROUND ART

For the electronic products represented by mobile phones, computers, video cameras and electronic games, the household and office electrical products represented by air conditionings, refrigerators, TV images, audio supplies and various products in other areas, different degrees of flame retardant property are required for safety.

In order to achieve desired flame retardancy or grade of the products, conventional techniques often use the addition of halogen-containing flame retardant materials to the material systems, e.g. by adding to the system material the organic chemicals containing higher amount of bromine or halogen, such as decabromodiphenyl ether, tetrabromobisphenol A, tetrabromodipentaerythritol, brominated polystyrene, pentabromotoluene or hexabromocyclododecane. Although these halogen-containing flame retardant materials have better flame retardancy, they are used in a greater amount. For example, in order to achieve better flame retardancy, the bromine amount in the composition of the flame retardant and epoxy resin is ensured to be higher than 20% when using the bromine-containing flame retardant for preparing copper clad plates, electronic materials and engineering plastics, thereby rendering a higher bromine content in the products. A high halogen content in the products can also bring some adverse effects. For example, refractory hazardous substances produced by high temperature or combustion, such as dioxin-based organic halogen chemicals, contaminate the environment and affect human and animal health.

Therefore, it is an urgent problem to be solved in the field how to reduce the use of flame retardants and to ensure the flame retardant effect.

### DISCLOSURE OF THE INVENTION

In view of the deficiencies of the prior art, the object of the present invention is to provide a composite flame retardant, a flame retardant resin composition, a composite metal substrate, a flame retardant electronic material and a flame retardant engineering plastic.

In order to achieve such object, the following technical solutions are used in the present invention.

On one aspect, the present invention provides a composite flame retardant comprising a bromine-containing flame retardant, a sulfur-containing flame retardant and/or a phosphorus-containing flame retardant, wherein said bromine-containing flame retardant is a bromine-containing phenol compound and epoxy resins thereof.

In the composite flame retardant of the present invention, the bromine-containing flame retardant is combined with the sulfur-containing flame retardant and/or phosphorus-containing flame retardant to form a synergistic flame retardant, which can provide a better flame retardant effect.

On the second aspect, the present invention provides a flame retardant resin composition comprising a halogen-free epoxy resin and the above composite flame retardant.

In the flame retardant resin composition of the present invention, the bromine-containing flame retardant is combined with the sulfur-containing flame retardant and/or phosphorus-containing flame retardant to form a synergistic flame retardant, which is further combined with the halogen-free epoxy resin, so as to provide the cured product of the composition with better flame retardancy, heat resistance, water resistance, higher peeling strength and thermal decomposition temperature.

The flame retardant resin composition of the present invention should necessarily comprise a bromine-containing flame retardant, either or both of a sulfur-containing flame retardant and a phosphorus-containing flame retardant. Preferably, the flame retardant resin composition comprises a bromine-containing flame retardant, a sulfur-containing flame retardant and a phosphorus-containing flame retardant, as well as a halogen-free epoxy resin, wherein the bromine-containing flame retardant is a bromine-containing phenol compound and epoxy resins thereof.

Preferably, the bromine element is in an amount of 10 wt. % or less, e.g. 10 wt. %, 9 wt. %, 8.5 wt. %, 8 wt. %, 7 wt. %, 7.5 wt. %, 6 wt. %, 5 wt. %, 4 wt. %, 3 wt. %, 2 wt. %, 1 wt. %, 0.5 wt. %, 0.3 wt. %, 0.1 wt. % and the like, preferably 1-10 wt. % of the flame retardant resin composition.

Preferably, the sulfur element is in an amount of 0.2 wt. % or more, e.g. 0.2 wt. %, 0.25 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 1.8 wt. %, 2 wt. % and the like, preferably 0.2-1 wt. % of the flame retardant resin composition.

Preferably, the phosphorus element is in an amount of 0.2 wt. % or more, e.g. 0.2 wt. %, 0.25 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 1.8 wt. %, 2 wt. %, 2.5 wt. %, 3 wt. %, 4 wt. %, 5 wt. % and the like, preferably 0.2-2 wt. % of the flame retardant resin composition.

Within the content ranges of the bromine element, the sulfur element and the phosphorus element defined by the present invention, the bromine-containing flame retardant, the sulfur-containing flame retardant and/or the phosphorus-containing flame retardant can be synergized to enhance the flame retardancy of the resin composition synergistically, which not only can ensure the resin composition to have a better flame retardancy, but also can control the content of the bromine element within a lower range, so as to reduce the possibility of producing hazardous substances due to high temperature. Within such content ranges, various performances of copper-clad laminates prepared from the flame retardant resin composition can be optimized to have better heat resistance, water resistance, higher thermal decomposition temperature, so as to improve the comprehensive performances of CCL.

In the present invention, the contents of bromine element, sulfur element and phosphorus element are based on 100 wt. % of the flame retardant resin composition.

Preferably, the bromine-containing flame retardant is anyone selected from the group consisting of brominated phenolic resin, brominated phenolic epoxy resin, brominated bisphenol A, brominated bisphenol A derivative, brominated bisphenol A type epoxy resin, tetrabromobisphenol S, tetrabromobisphenol allyl ether, tribromophenol and pentabromophenol, or a combination of at least two selected therefrom, preferably brominated bisphenol A, brominated bisphenol A derivative or brominated bisphenol A type epoxy resin.

Preferably, the sulfur-containing flame retardant is p-benzenedithiol and/or 4,4′-diaminodiphenyl disulfide, preferably p-benzenedithiol.

Preferably, the phosphorus-containing flame retardant is anyone selected from the group consisting of DOPO etherified bisphenol A, DOPO modified epoxy resin, tri-(2,6-dimethylphenyl)phosphine, tetra-(2,6-dimethylphenyl)resorcinol bisphosphate, resorcinol tetraphenyl diphosphate, triphenyl phosphate, bisphenol A bis-(diphenyl phosphate), phosphonitrile flame retardant, 10-(2,5-dihydroxyphenyl)-10-hydro-9-oxa-10-phosphaphenanthrene-10-oxide, 10-(2,5-dihydroxynaphthyl)-10-hydro-9-oxa-10-phosphaphenanthrene-10-oxide and 9,10-dihydro-9-oxa-10-phosphaphenanthrene-10-oxide, or a mixture of at least two selected therefrom.

The flame retardant resin composition may also comprise other flame retardant materials as desired.

Preferably, said other flame retardant material is anyone selected from the group consisting of organosilicone flame retardant, chlorine-containing organic flame retardant, nitrogen-containing organic flame retardant and inorganic flame retardant, or a combination of at least two selected therefrom.

Preferably, the chlorine-containing organic flame retardant is anyone selected from the group consisting of dioctyl tetrachlorophthalate, chlorendic anhydride, chlorendic acid and tetrachlorobisphenol A, or a combination of at least two selected therefrom.

Preferably, the nitrogen-containing organic flame retardant is anyone selected from the group consisting of dicyandiamide, biurea and melamine, or a combination of at least two selected therefrom.

Preferably, the inorganic flame retardant is anyone selected from the group consisting of aluminum hydroxide, magnesium hydroxide, antimony trioxide and zinc borate, or a combination of at least two selected therefrom.

Preferably, the halogen-free epoxy resin is anyone selected from the group consisting of bisphenol A type epoxy resin, bisphenol F type epoxy resin, phenol type novolac epoxy resin, bisphenol A type novolac epoxy resin, o-cresol novolac epoxy resin, dicyclopentadiene type epoxy resin, isocyanate type epoxy resin and biphenyl type epoxy resin, or a combination of at least two selected therefrom.

Preferably, the halogen-free epoxy resin is in an amount of 70-90 wt. %, e.g. 70 wt. %, 73 wt. %, 75 wt. %, 78 wt. %, 80 wt. %, 83 wt. %, 85 wt. %, 88 wt. % or 90 wt. %, in the flame retardant resin composition.

On another aspect, the present invention provides a thermosetting resin composition comprising the flame retardant resin composition above.

Preferably, the thermosetting resin composition further comprises a curing agent.

Preferably, the curing agent is anyone selected from the group consisting of dicyandiamide, phenolic resin, aromatic amine, anhydride, active ester curing agent and active phenolic curing agent, or a mixture of at least two selected therefrom.

Preferably, the thermosetting resin composition further comprises a curing accelerator.

Preferably, the curing accelerator is anyone selected from the group consisting of imidazole curing accelerator, organic phosphine curing accelerator and tertiary amine curing accelerator, or a mixture of at least two selected therefrom.

Preferably, the imidazole curing accelerator is anyone selected from the group consisting of 2-methylimidazole, 2-ethyl-4-methylimidazole, 2-phenylimidazole, 2-undecyl-imidazole, 1-benzyl-2-methylimidazole, 2-heptadecylimidazole, 2-isopropyl-imidazole, 2-phenyl-4-methylimidazole, 2-dodecylimidazole and 1-cyanoethyl-2-methylimidazole, or a mixture of at least two selected therefrom, preferably 2-methylimidazole.

On another aspect, the present invention provides a prepreg prepared by impregnating or coating a substrate with the thermosetting resin composition above.

Preferably, the substrate is selected from the group consisting of glass fiber substrate, polyester substrate, polyimide substrate, ceramic substrate, or carbon fiber substrate.

In the present invention, there are no limits to the specific process conditions of the impregnating or coating. The “prepreg” is “bonding sheet” well-known to the skilled in the art.

The present invention further provides a composite metal substrate, and the substrate is prepared by surface-coating a metal layer, overlapping and laminating in sequence at least one sheet of the prepreg above.

Preferably, the metal layer coated on the surface is selected from the group consisting of aluminium, copper, iron, and an alloy of any combination thereof.

Preferably, the composite metal substrate is anyone selected from the group consisting of CEM-1 copper-clad laminate, CEM-3 copper-clad laminate, FR-4 copper-clad laminate, FR-5 copper-clad laminate, CEM-1 aluminum-clad laminate, CEM-3 aluminum-clad laminate, FR-4 aluminum-clad laminate and FR-5 aluminum-clad laminate.

The present invention further provides a circuit board prepared by processing circuits on the surface of the composite metal substrate above.

On another aspect, the present invention provides a flame retardant electronic material comprising the flame retardant resin composition as stated above.

Preferably, the flame retardant electronic material comprises 60-80 parts by weight (e.g. 62, 64, 66, 68, 70, 73, 75 or 78 parts by weight) of the flame retardant resin composition, 10-20 parts by weight (e.g. 11, 12, 13, 14, 15, 16, 17, 18 or 19 parts by weight) of an organosilicone filler, 2-5 parts by weight (e.g. 2, 2.5, 3, 3.5, 4 or 4.5 parts by weight) of a curing agent, 0.5-2 parts by weight (e.g. 0.8, 1, 1.3, 1.5, 1.8 or 2 parts by weight) of a curing accelerator, 2-6 parts by weight (e.g. 2.5, 3, 3.5, 4, 4.5, 5 or 5.5 parts by weight) of a diluent and 1-3 parts by weight (e.g. 1.3, 1.5, 1.8, 2, 2.3, 2.5 or 2.8 parts by weight) of a defoamer.

Preferably, the organosilicon filler is N-(β-aminoethyl)-γ-aminopropyl-triethoxysilane and/or glycidyloxypropyltrimethoxysilane.

Preferably, the curing agent is anyone selected from the group consisting of 4,4-diaminodiphenyl ether, 4,4-diaminodiphenyl sulfone, methyltetrahydrophthalic anhydride and methylhexahydrophthalic anhydride, or a mixture of at least two selected therefrom.

Preferably, the curing accelerator is anyone selected from the group consisting of 2-methylimidazole, resorcinol, dimethylbenzylamine and 2-ethyl-4-methylimidazole, or a combination of at least two selected therefrom.

Preferably, the diluent is acetone.

The flame retardant electronic material of the present invention is prepared by mixing the raw materials of the flame retardant electronic material and preparing the flame retardant electronic material according to the known methods in the prior art. For example, a flame retardant resin composition is used to prepare a pouring sealant. The pouring sealant can be prepared from the flame retardant resin composition and other raw materials according to the methods of preparing pouring sealants well known to those skilled in the art. The prepared pouring sealant has good flame retardant property, short dry-working time, low viscosity, as well as good stability.

On another aspect, the present invention provides a flame retardant engineering plastic comprising the composite flame retardant as stated above and an engineering plastic main material.

Preferably, the bromine-containing flame retardant is in an amount of 10 wt. % or less, e.g. 10 wt. %, 9 wt. %, 8.5 wt. %, 8 wt. %, 7 wt. %, 7.5 wt. %, 6 wt. %, 5 wt. %, 4 wt. %, 3 wt. %, 2 wt. %, 1 wt. %, 0.5 wt. %, 0.3 wt. %, 0.1 wt. % and the like, preferably 1-5 wt. % of the flame retardant engineering plastic.

Preferably, the sulfur-containing flame retardant is in an amount of 0.2 wt. % or more, e.g. 0.2 wt. %, 0.25 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 1.8 wt. %, 2 wt. % and the like, preferably 0.2-1 wt. % of the flame retardant engineering plastic.

Preferably, the phosphorus-containing flame retardant is in an amount of 0.2 wt. % or more, e.g. 0.2 wt. %, 0.25 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 1.8 wt. %, 2 wt. %, 2.5 wt. %, 3 wt. %, 4 wt. %, 5 wt. % and the like, preferably 0.2-2 wt. % of the flame retardant engineering plastic.

Within the content ranges of the bromine element, the sulfur element and the phosphorus element defined by the present invention, the bromine-containing flame retardant, the sulfur-containing flame retardant and/or the phosphorus-containing flame retardant can be synergized to enhance the flame retardancy, which not only can ensure the engineering plastic to have a better flame retardancy, but also can control the content of the bromine element within a lower range, so as to reduce the possibility of producing hazardous substances due to high temperature. Within such content ranges, various performances of the prepared flame retardant engineering plastic can be optimized to have better mechanical properties and flame retardancy.

In the present invention, the contents of each component in the flame retardant engineering plastic are based on 100 wt. % of the flame retardant engineering plastic.

Preferably, the engineering plastic main material in the flame retardant engineering plastic is anyone selected from the group consisting of polyvinyl chloride, ABS resin, polypropylene, polycarbonate, polystyrene and polyurethane, or a combination of at least two selected therefrom.

Preferably, the engineering plastic main material is in an amount of 80-95 wt. %, e.g. 80 wt. %, 83 wt. %, 85 wt. %, 88 wt. %, 90 wt. %, 92 wt. %, 94 wt. % or 95 wt. %, of the flame retardant engineering plastic.

Preferably, the flame retardant polystyrene plastic further comprises 1-3 wt. %, e.g. 1 wt. %, 1.3 wt. %, 1.5 wt. %, 1.8 wt. %, 2 wt. %, 2.3 wt. %, 2.5 wt. %, 2.8 wt. % or 3 wt. %, of a heat-resistant modifier.

Preferably, the heat-resistant modifier is N-2,6-dimethylphenylmaleimide heat-resistant modifier.

Preferably, the flame retardant polystyrene plastic further comprises 1-3 wt. %, e.g. 1 wt. %, 1.3 wt. %, 1.5 wt. %, 1.8 wt. %, 2 wt. %, 2.3 wt. %, 2.5 wt. %, 2.8 wt. % or 3 wt. %, of an antioxidant.

Preferably, the antioxidant is anyone selected from the group consisting of antioxidant 1010, antioxidant 168 and antioxidant 1076, or a combination of at least two selected therefrom.

The flame-retardant engineering plastic of the present invention is prepared by mixing the raw materials homogeneously, then extruding and granulating to obtain the flame-retardant engineering plastic.

Preferably, the mixing is carried out in a high pressure homogenizer at a temperature of 60-80° C. (e.g. 62° C., 65° C., 68° C., 70° C., 72° C., 74° C., 76° C. or 78° C.) for 10-20 min (e.g. 12 min, 14 min, 16 min or 18 min), at a pressure of 15-20 MPa (e.g. 16 MPa, 17 MPa, 18 MPa or 19 MPa).

Preferably, the extrusion is carried out in a twin-screw extruder at a temperature of 170-180° C. (e.g. 170° C., 173° C., 175° C., 178° C. or 180° C.) in a first zone, 180-190° C. (e.g. 180° C., 183° C., 185° C., 188° C. or 190° C.) in a second zone, 210-230° C. (e.g. 210° C., 212° C., 215° C., 218° C., 220° C., 223° C., 225° C., 228° C. or 230° C.) in a third zone, 240-260° C. (e.g. 240° C., 243° C., 245° C., 248° C., 250° C., 253° C., 255° C., 258° C. or 260° C.) in a fourth zone, 170-180° C. (e.g. 170° C., 173° C., 175° C., 178° C. or 180° C.) in a fifth zone.

As compared to the prior art, the present invention has the following beneficial effects.

The bromine-containing flame retardant, the sulfur-containing flame retardant and/or the phosphorus-containing flame retardant in the composite flame retardant of the present invention have a synergistic effect on the flame retardant effect to enhance the flame retardancy of the resin composition. The cured product of the flame retardant resin composition of the present invention has good heat resistance, water resistance, cohesiveness, mechanical properties and electrical properties, and is an environmentally friendly flame retardant composition having a great economy. The copper clad laminate prepared from the flame retardant resin composition of the present invention has a thermal decomposition temperature (5% weight loss) of as high as 353° C. or higher, a peeling strength of up to 1.8 kg/mm² or more, T-288 of more than 100 seconds, a heat-resistant limit of tin dipping of more than 31 times, a saturated water absorption of 0.35% or less, a flammability (UL-94) of V-0 level. The pouring sealant prepared from the flame retardant resin composition of the present invention has a surface drying time of 9-12 min at 80° C., a viscosity of 2500-3500 mPa·s, a thermal conductivity of 1.2-1.36 w/m·K and a hardness of 40-45 A, a better stability, a flame retardancy of V-0 level. Due to the composite flame retardant of the present invention, the prepared ABS composite material has a bending strength of as high as 82-84 MPa, a tensile strength of as high as 67-68.4 MPa, a notch impact strength of up to 28.1-29.5 J/m, a heat distortion temperature of 130-136° C., a melting index of 13.2-15, an oxygen index of 26.2-27.5%, with good flame resistancy, excellent mechanical properties and heat resistance.

### EMBODIMENTS

The technical solutions of the present invention will be further described by the following specific embodiments. Those skilled in the art shall know that the examples are merely illustrative of the present invention and should not be construed as limiting the present invention.

### Example 1

26.4 g of a brominated bisphenol A type epoxy resin having an epoxy equivalent of 400 g/eq and a bromine content of 48.5%, and 1.42 g of p-benzenedithiol having a sulfur content of 45% were added into 100 g of a liquid bisphenol A type epoxy resin having an epoxy equivalent of 186 g/eq and mixed, to obtain a flame retardant resin mixture having a bromine content of 10% and a sulfur content of 0.5%. An appropriate amount of acetone was added to dissolve the mixture. Then 6.4 g of dicyandiamide and 0.1 g of 2-methylimidazole were added and fully dissolved, to prepare a standard CCL in line with national standard, UL and other standards according to a common CCL production process. Such CCL was called CCL A, and the performance test results thereof are shown in Table 1 as follows.

### Example 2

20.8 g of a brominated bisphenol A having a phenolic hydroxyl equivalent of 272 g/eq and a bromine content of 58.5%, and 0.68 g of p-benzenedithiol having a sulfur content of 45% were added into 100 g of a liquid bisphenol A type epoxy resin having an epoxy equivalent of 186 g/eq and mixed, to obtain a resin mixture having a bromine content of 10% and a sulfur content of 0.25%. An appropriate amount of acetone was added to dissolve the mixture. Then 47.4 g of a linear novolac resin having a phenolic hydroxyl equivalent of 105 g/eq and 0.1 g of 2-methylimidazole were added and fully dissolved, to prepare a standard CCL in line with national standard, UL and other standards according to a common CCL production process. Such CCL was called CCL B, and the performance test results thereof are shown in Table 1 as follows.

### Example 3

11.9 g of a brominated bisphenol A epoxy resin having an epoxy equivalent of 400 g/eq and a bromine content of 48.5%, and 2.1 g of 4,4′-diaminodiphenyl disulfide having a sulfur content of 14.8% were added into 100 g of o-cresol novolac epoxy resin having an epoxy equivalent of 200 g/eq and mixed, to obtain a resin mixture having a bromine content of 5% and a sulfur content of 0.25%. An appropriate amount of acetone was added to dissolve the mixture. Then 59.7 g of a linear novolac resin curing agent having a phenolic hydroxyl equivalent of 105 g/eq and 0.1 g of 2-methylimidazole were added and fully dissolved, to prepare a standard CCL in line with national standard, UL and other standards according to a common CCL production process. Such CCL was called CCL C, and the performance test results thereof are shown in Table 1 as follows.

### Example 4

31.0 g of a brominated bisphenol A epoxy resin having an epoxy equivalent of 400 g/eq and a bromine content of 48.5%, and 14 g of tetra-(2,6-dimethylphenyl)-resorcinol bisphosphate having a phosphorus content of 9.0% were added into 100 g of a liquid bisphenol A type epoxy resin having an epoxy equivalent of 186 g/eq and mixed, to obtain a flame retardant resin mixture having a bromine content of 10% and a phosphorus content of 1.0%. An appropriate amount of acetone was added to dissolve the mixture. Then 6.7 g of dicyanodiamide and 0.1 g of 2-methylimidazole were added and fully dissolved, to prepare a CCL according to a common process. Such CCL was called CCL D, and the performance test results thereof are shown in Table 1 as follows.

### Example 5

25.5 g of a brominated bisphenol A having a phenolic hydroxyl equivalent of 272 g/eq and a bromine content of 58.5%, and 23.0 g of DOPO-etherified bisphenol A having a phenolic hydroxyl equivalent of 300 g/eq and a phosphorus content of 10.0% were added into 100 g of a liquid bisphenol A type epoxy resin having an epoxy equivalent of 186 g/eq and mixed, to obtain a flame retardant resin mixture having a bromine content of 10% and a phosphorus content of 1.5%. An appropriate amount of acetone was added to dissolve the mixture. Then 38.6 g of a linear novolac resin having a phenolic hydroxyl equivalent of 105 g/eq and 0.1 g of 2-methylimidazole were added and fully dissolved, to prepare a CCL according to a common process. Such CCL was called CCL E, and the performance test results thereof are shown in Table 1 as follows.

### Example 6

44.8 g of a brominated bisphenol A epoxy resin having an epoxy equivalent of 400 g/eq and a bromine content of 48.5%, and 72.5 g of DOPO-modified epoxy resin having an epoxy equivalent of 300 g/eq and a phosphorus content of 3.0% were added into 100 g of a liquid bisphenol A type epoxy resin having an epoxy equivalent of 186 g/eq and mixed, to obtain a flame retardant resin mixture having a bromine content of 10% and a phosphorus content of 1.0%. An appropriate amount of acetone was added to dissolve the mixture. Then 9.7 g of dicyandiamide and 0.1 g of 2-methylimidazole were added and fully dissolved, to prepare a CCL according to a common process. Such CCL was called CCL F, and the performance test results thereof are shown in Table 1 as follows.

### Example 7

9.3 g of a brominated bisphenol A having a phenolic hydroxyl equivalent of 272 g/eq and a bromine content of 58.5%, and 5.7 g of DOPO-etherified bisphenol A having a phenolic hydroxyl equivalent of 300 g/eq and a phosphorus content of 10.0% were added into 100 g of a liquid bisphenol A type epoxy resin having an epoxy equivalent of 186 g/eq and mixed, to obtain a flame retardant resin mixture having a bromine content of 5% and a phosphorus content of 0.5%. An appropriate amount of acetone was added to dissolve the mixture. Then 50.9 g of a linear novolac resin having a phenolic hydroxyl equivalent of 105 g/eq and 0.1 g of 2-methylimidazole were added and fully dissolved, to prepare a CCL according to a common process. Such CCL was called CCL G, and the performance test results thereof are shown in Table 1 as follows.

### Example 8

13.2 g of a brominated bisphenol A epoxy resin having an epoxy equivalent of 400 g/eq and a bromine content of 48.5%, 1.43 g of p-benzenedithiol having a sulfur content of 45% and 14.8 g of tetra-(2,6-dimethylphenyl)-resorcinol bisphosphate having a phosphorus content of 10.0% were added into 100 g of a liquid bisphenol A type epoxy resin having an epoxy equivalent of 186 g/eq and mixed, to obtain a flame retardant resin mixture having a bromine content of 5%, a sulfur content of 0.5% and a phosphorus content of 1.0%. An appropriate amount of acetone was added to dissolve the mixture. Then 6.0 g of dicyanodiamide and 0.1 g of 2-methylimidazole were added and fully dissolved, to prepare a CCL according to a common process. Such CCL was called CCL H, and the performance test results thereof are shown in Table 1 as follows.

### Example 9

11.2 g of a brominated bisphenol A having a phenolic hydroxyl equivalent of 272 g/eq and a bromine content of 58.5%, 0.6 g of p-benzenedithiol having a sulfur content of 45% and 19.8 g of DOPO-etherified bisphenol A having a phenolic hydroxyl equivalent of 300 g/eq and a phosphorus content of 10.0% were added into 100 g of a liquid bisphenol A type epoxy resin having an epoxy equivalent of 186 g/eq and mixed, to obtain a flame retardant resin mixture having a bromine content of 5%, a sulfur content of 0.2% and a phosphorus content of 1.5%. An appropriate amount of acetone was added to dissolve the mixture. Then 44.3 g of a linear novolac resin having a phenolic hydroxyl equivalent of 105 g/eq and 0.1 g of 2-methylimidazole were added and fully dissolved, to prepare a CCL according to a common process. Such CCL was called CCL J, and the performance test results thereof are shown in Table 1 as follows.

### Example 10

7.6 g of a brominated bisphenol A epoxy resin having an epoxy equivalent of 400 g/eq and a bromine content of 48.5%, 8.4 g of 4,4′-diaminodiphenyl disulfide having a sulfur content of 14.8% and 8.3 g of a general DOPO-modified epoxy resin having an epoxy equivalent of 300 g/eq and a phosphorus content of 3.0% were added into 100 g of a liquid bisphenol A type epoxy resin having an epoxy equivalent of 186 g/eq and mixed, to obtain a flame retardant resin mixture having a bromine content of 3%, a sulfur content of 1% and a phosphorus content of 0.2%. An appropriate amount of acetone was added to dissolve the mixture. Then 5.5 g of dicyandiamide and 0.1 g of 2-methylimidazole were added and fully dissolved, to prepare a CCL according to a common process. Such CCL was called CCL K, and the performance test results thereof are shown in Table 1 as follows.

### Example 11

1.9 g of a brominated bisphenol A having a phenolic hydroxyl equivalent of 272 g/eq and a bromine content of 58.5%, 1.2 g of p-benzenedithiol having a sulfur content of 45% and 8.9 g of DOPO-etherified bisphenol A having a phenolic hydroxyl equivalent of 300 g/eq and a phosphorus content of 10.0% were added into 100 g of a liquid bisphenol A type epoxy resin having an epoxy equivalent of 186 g/eq and mixed, to obtain a flame retardant resin mixture having a bromine content of 1%, a sulfur content of 0.5% and a phosphorus content of 0.8%. An appropriate amount of acetone was added to dissolve the mixture. Then 50.8 g of a linear novolac resin having a phenolic hydroxyl equivalent of 105 g/eq and 0.1 g of 2-methylimidazole were added and fully dissolved, to prepare a CCL according to a common process. Such CCL was called CCL L, and the performance test results thereof are shown in Table 1 as follows.

### Comparison Example 1

2.6 g of dicyandiamide and 0.1 g of 2-methylimidazole were added into 100 g (solid calculation) of a brominated bisphenol A epoxy resin having an epoxy equivalent of 420 g/eq and a bromine content of 20% and satisfying the market circulation standards. An appropriate amount of acetone was added to dissolve the mixture, to prepare a CCL according to a common process. Such CCL was called CCL M, and the performance test results thereof are shown in Table 2 as follows.

### Comparison Example 2

16.7 g (solid calculation) of a brominated bisphenol A epoxy resin having an epoxy equivalent of 420 g/eq and a bromine content of 20% and satisfying the market circulation standards was mixed with 50 g of a liquid bisphenol A type epoxy resin having an epoxy equivalent of 186 g/eq, to obtain an epoxy resin composition having a bromine content of 5%. An appropriate amount of acetone was added to dissolve the mixture. Then 32.4 g of a linear novolac resin having a phenolic hydroxyl equivalent of 105 g/eq and 0.1 g of 2-methylimidazole were added and fully dissolved, to prepare a CCL according to a common process. Such CCL was called CCL N, and the performance test results thereof are shown in Table 2 as follows.

### Comparison Example 3

27.6 g of a brominated bisphenol A epoxy resin having an epoxy equivalent of 400 g/eq and a bromine content of 48.5% was added to 100 g of a liquid bisphenol A type epoxy resin having an epoxy equivalent of 186 g/eq and mixed, to obtain a flame retardant epoxy resin mixture having a bromine content of 10.5%. An appropriate amount of acetone was added to dissolve the mixture. Then 6.4 g of dicyandiamide and 0.1 g of 2-methylimidazole were added and fully dissolved, to prepare a standard CCL in line with national standard, UL and other standards according to a common CCL production process. Such CCL was called CCL P, and the performance test results thereof are shown in Table 2 as follows.

### Comparison Example 4

30.4 g of p-benzenedithiol having a sulfur content of 45% was added to 100 g of a liquid bisphenol A type epoxy resin having an epoxy equivalent of 186 g/eq and mixed, to obtain a flame retardant epoxy resin mixture having a sulfur content of 10.5%. An appropriate amount of acetone was added to dissolve the mixture. Then 6.4 g of dicyandiamide and 0.1 g of 2-methylimidazole were added and fully dissolved, to prepare a standard CCL in line with national standard, UL and other standards according to a common CCL production process. Such CCL was called CCL Q, and the performance test results thereof are shown in Table 2 as follows.

### Comparison Example 5

29.3 g of a brominated bisphenol A epoxy resin having an epoxy equivalent of 400 g/eq and a bromine content of 48.5% was added to 100 g of a liquid bisphenol A type epoxy resin having an epoxy equivalent of 186 g/eq and mixed, to obtain a flame retardant epoxy resin mixture having a bromine content of 11%. An appropriate amount of acetone was added to dissolve the mixture. Then 6.7 g of dicyandiamide and 0.1 g of 2-methylimidazole were added and fully dissolved, to prepare according to a common process. Such CCL was called CCL R, and the performance test results thereof are shown in Table 2 as follows.

### Comparison Example 6

122 g of DOPO-etherified bisphenol A having a phenolic hydroxyl equivalent of 300 g/eq and a phosphorus content of 10.0% was added into 100 g of a liquid bisphenol A type epoxy resin having an epoxy equivalent of 186 g/eq and mixed, to obtain a flame retardant resin mixture having a phosphorus content of 5.5%. An appropriate amount of acetone was added to dissolve the mixture. Then 13.7 g of a linear novolac resin having a phenolic hydroxyl equivalent of 105 g/eq and 0.1 g of 2-methylimidazole were added and fully dissolved, to prepare according to a common process. Such CCL was called CCL S, and the performance test results thereof are shown in Table 2 as follows.

### Comparison Example 7

15.7 g of p-benzenedithiol having a sulfur content of 45% and 12.8 g of tetra-(2,6-dimethylphenyl)-resorcinol bisphosphate having a phosphorus content of 10.0% were added into 100 g of a liquid bisphenol A type epoxy resin having an epoxy equivalent of 186 g/eq and mixed, to obtain a flame retardant resin mixture having a sulfur content of 5.5% and a phosphorus content of 1.0%. An appropriate amount of acetone was added to dissolve the mixture. Then 3.5 g of dicyanodiamide and 0.1 g of 2-methylimidazole were added and fully dissolved, to prepare according to a common process. Such CCL was called CCL T, and the performance test results thereof are shown in Table 2 as follows.

### Comparison Example 8

2.86 g of p-benzenedithiol having a sulfur content of 45% and 154.5 g of tetra-(2,6-dimethylphenyl)-resorcinol bisphosphate having a phosphorus content of 10.0% were added into 100 g of a liquid bisphenol A type epoxy resin having an epoxy equivalent of 186 g/eq and mixed, to obtain a flame retardant resin mixture having a sulfur content of 0.5% and a phosphorus content of 6.0%. An appropriate amount of acetone was added to dissolve the mixture. Then 5.4 g of dicyanodiamide and 0.1 g of 2-methylimidazole were added and fully dissolved, to prepare according to a common process. Such CCL was called CCL U, and the performance test results thereof are shown in Table 2 as follows.

TABLE 1

| Test | | CCL | CCL | CCL | CCL | CCL | CCL | CCL | CCL | CCL | CCL |
|---|---|---|---|---|---|---|---|---|---|---|---|
| items | Units | A | B | C | D | E | F | G | H | I | J |
| Thermal | 5% | 353 | 358 | 360 | 362 | 371 | 368 | 363 | 395 | 389 | 390 |
| decomposition | weight | | | | | | | | | | |
| temperature | loss/ | | | | | | | | | | |
| | ° C. | | | | | | | | | | |
| Peeling | kg/c | 2.1 | 1.8 | 1.9 | 2.1 | 1.9 | 2.2 | 2.0 | 2.8 | 2.9 | 2.7 |
| strength | m² | | | | | | | | | | |
| T-288 | s | >100 | >100 | >100 | >100 | >100 | >100 | >100 | >100 | >100 | >100 |
| Heat | times/ | 31 | 38 | 34 | 31 | 38 | 37 | 34 | 45 | 43 | 41 |
| resistant | tin | | | | | | | | | | |
| limit | dipping | | | | | | | | | | |
| Saturated | wt %/ | 0.35 | 0.24 | 0.28 | 0.35 | 0.24 | 0.31 | 0.32 | 0.19 | 0.2 | 0.18 |
| water | PCT | | | | | | | | | | |
| absorption | | | | | | | | | | | |
| Flame | UL- | V-0 | V-0 | V-0 | V-0 | V-0 | V-0 | V-0 | V-0 | V-0 | V-0 |
| retardancy | 94 | | | | | | | | | | |

TABLE 2

| Test | | CCL | CCL | CCL | CCL | CCL | CCL | CCL | CCL | CCL |
|---|---|---|---|---|---|---|---|---|---|---|
| items | Units | L | M | N | P | Q | R | S | T | U |
| Thermal | 5% weight | 385 | 298 | 286 | 267 | 255 | 269 | 272 | 242 | 243 |
| decomposition | loss/° C. | | | | | | | | | |
| temperature | | | | | | | | | | |
| Peeling | kg/cm² | 2.7 | 1.8 | 1.2 | 1.0 | 1.0 | 1.0 | 1.3 | 1.0 | 1.1 |
| strength | | | | | | | | | | |
| T-288 | s | >100 | 15 | 21 | 22 | 24 | 22 | 25 | 8 | 9 |
| Heat | times/tin | 40 | 5 | 8 | 7 | 9 | 7 | 9 | 7 | 7 |
| resistant | dipping | | | | | | | | | |
| limit | | | | | | | | | | |
| Saturated | wt %/ | 0.2 | 0.48 | 0.42 | 0.45 | 0.43 | 0.45 | 0.41 | 0.46 | 0.45 |
| water | PCT | | | | | | | | | |
| absorption | | | | | | | | | | |
| Flame | UL-94 | V-0 | V-0 | complete | complete | complete | complete | complete | complete | complete |
| retardancy | | | | combustion | combustion | combustion | combustion | combustion | combustion | combustion |

As can be seen from the test results in Tables 1 and 2, the CCL prepared by using the flame retardant resin composition of the present invention has a thermal decomposition temperature (5% weight loss) of as high as 353° C. or higher, a peeling strength of up to 1.8 kg/mm² or more, T-288 of more than 100 seconds, a heat-resistant limit of 31 times or more, a saturated water absorption of 0.35% or less, and a flammability (UL-94) of V-0 level.

When a brominated bisphenol A type epoxy resin having a bromine content of 20% and an epoxy equivalent of 420 g/eq and satisfying the market circulation standards was used instead of adding a sulfur-containing flame retardant (Comparison Example 1), the prepared CCL D has a lower thermal decomposition temperature and is unstable, although it still has a flame retardancy at the V-0 level, and the bromine content is increased to 20%. In addition, its T-288 is only 15 seconds; the heat resistant limit is only 5 times, and the saturated water absorption is higher. When a brominated bisphenol A type epoxy resin having a bromine content of 20% and an epoxy equivalent of 420 g/eq and satisfying the market circulation standards was used as the flame retardant, instead of using the sulfur-containing flame retardant, and mixed with a liquid bisphenol A type epoxy resin having an epoxy equivalent of 186 g/eq to maintain the bromine content thereof in the epoxy resin composition to be 10% (Comparison Example 2) as Example 1, the prepared CCL E has a flame retardancy which is greatly decreased, a heat resistant limit of only 8 times, a low thermal decomposition temperature, a low peeling strength and a high saturated water absorption.

As compared to Example 1, when a sulfur-containing flame retardant was not used, and the amount of the bromine-containing flame retardant was increased so that the content of the bromine element was equal to the sum of the contents of bromine and sulfur elements in Example 1 (Comparison Example 3), the prepared CCL has a poor flame retardancy or other performances. Similarly, when a bromine-containing flame retardant was not used, and the amount of the sulfur-containing flame retardant was increased so that the content of the sulfur element was equal to the sum of the contents of bromine and sulfur elements in Example 1 (Comparison Example 4), the prepared CCL also has a poor flame retardancy or other performances. This shows that the bromine-containing flame retardant and the sulfur-containing flame retardant of the present invention have a synergistic effect on the flame retardancy. Moreover, a very few amount of the sulfur element in the composition can be combined with the bromine-containing phenol compound and epoxy resins thereof to greatly increase the flame retardancy of the prepared CCL. The present invention discloses using a bromine-containing phenol compound and epoxy resins thereof as a bromine-containing flame retardant, in combination with a sulfur-containing flame retardant and a halogen-free epoxy resin, to make the prepared CCL have better comprehensive performances.

As compared to Example 4, when a phosphorus-containing flame retardant was not used, and the amount of the bromine-containing flame retardant was increased so that the content of the bromine element was equal to the sum of the contents of bromine and sulfur elements in Example 4 (Comparison Example 5), the prepared CCL has a poor flame retardancy or other performances. As compared to Example 7, when a bromine-containing flame retardant was not used, and the amount of the phosphorus-containing flame retardant was increased so that the content of the phosphorus element was equal to the sum of the contents of bromine and phosphorus elements in Example 7 (Comparison Example 6), the prepared CCL also has a poor flame retardancy or other performances. This shows that the bromine-containing flame retardant and the sulfur-containing flame retardant of the present invention have a synergistic effect on the flame retardancy. Moreover, the present invention discloses using a bromine-containing phenol compound and epoxy resins thereof as a bromine-containing flame retardant, in combination with a phosphorus-containing flame retardant and a halogen-free epoxy resin, to make the prepared CCL have better comprehensive performances.

As compared to Example 8, when a bromine-containing flame retardant was not used, the prepared CCL has a poor flame retardancy, even if the content of the sulfur element is increased so as to equal to the sum of the contents of bromine and sulfur elements in Example 8 (Comparison Example 7), or the content of the phosphorus element is increased so as to equal to the sum of the contents of bromine and phosphorus elements in Example 8 (Comparison Example 8), the prepared CCL has a poor flame retardancy. Other performances thereof, such as heat resistance, water resistance and the like, are also poor.

Therefore, the bromine-containing flame retardant can be combined with the sulfur-containing flame retardant and/or the phosphorus-containing flame retardant in the present invention to compose a synergistic flame retardant. The present invention discloses using a bromine-containing phenol compound and epoxy resins thereof as a bromine-containing flame retardant, combining with the sulfur-containing flame retardant and/or the phosphorus-containing flame retardant and the halogen-free epoxy resin, to make the prepared CCL have good comprehensive performances. The present invention discloses that the CCL has better flame retardancy, heat resistance, water resistance and good mechanical properties, while reducing the content of the bromine element.

### Example 12

26.4 g of a brominated bisphenol A type epoxy resin having an epoxy equivalent of 400 g/eq and a bromine content of 48.5% and 1.42 g of p-benzenedithiol having a sulfur content of 45% were added into 100 g of a liquid bisphenol A type epoxy resin having an epoxy equivalent of 186 g/eq and mixed, to obtain a flame retardant resin mixture having a bromine content of 10% and a sulfur content of 0.5%. 70 parts by weight of such flame retardant resin composition, 15 parts by weight of N-(β-aminoethyl)-γ-aminopropyl-triethoxysilane, 2 parts by weight of 4-diamino-diphenyl ether, 1 part by weight of 2-methylimidazole, 3 parts by weight of 1,4-butanediol diglycidyl ether and 2 parts by weight of a defoamer airex940 were used to prepare a pouring sealant A in accordance with a common method in the art.

The performance test results thereof are shown in Table 3 as follows.

### Example 13

31.0 g of a brominated bisphenol A type epoxy resin having an epoxy equivalent of 400 g/eq and a bromine content of 48.5% and 14 g of tetra-(2,6-dimethylphenyl) resorcinol bisphosphonate having a phosphorus content of 9.0% were added into 100 g of a liquid bisphenol A type epoxy resin having an epoxy equivalent of 186 g/eq and mixed, to obtain a flame retardant resin mixture having a bromine content of 10% and a phosphorus content of 1%. 75 parts by weight of such flame retardant resin composition, 13 parts by weight of glycidoxypropyltrimethoxysilane, 4 parts by weight of hexahydrophthalic anhydride, 0.5 part by weight of 2-ethyl-4-methylimidazole, 2 parts by weight of 1,6-hexanediol diglycidyl ether and 1 part by weight of a defoamer airex940 were used to prepare a pouring sealant D in accordance with a common method in the art. The performance test results thereof are shown in Table 3 as follows.

### Example 14

9.3 g of a brominated bisphenol A type epoxy resin having a phenolic hydroxyl equivalent of 272 g/eq and a bromine content of 58.5% and 5.7 g of DOPO-etherified bisphenol A having a phenolic hydroxyl equivalent of 300 g/eq and a phosphorus content of 10% were added into 100 g of a liquid bisphenol A type epoxy resin having an epoxy equivalent of 186 g/eq and mixed, to obtain a flame retardant resin mixture having a bromine content of 5% and a phosphorus content of 0.5%. 70 parts by weight of such flame retardant resin composition, 10 parts by weight of N-(β-aminoethyl)-γ-aminopropyl-triethoxysilane, 5 parts by weight of 4,4-diaminodiphenylsulfone, 2 parts by weight of 2-ethyl-4-methylimidazole, 2 parts by weight of ethylene glycol diglycidyl ether and 1 part by weight of a defoamer airex940 were used to prepare a pouring sealant G in accordance with a common method in the art. The performance test results thereof are shown in Table 3 as follows.

### Example 15

13.2 g of a brominated bisphenol A type epoxy resin having an epoxy equivalent of 400 g/eq and a bromine content of 48.5%, 1.43 g of p-benzenedithiol having a sulfur content of 45% and 14.8 g of tetra-(2,6-dimethylphenyl) resorcinol bisphosphonate having a phosphrous content of 10.0% were added into 100 g of a liquid bisphenol A type epoxy resin having an epoxy equivalent of 186 g/eq and mixed, to obtain a flame retardant resin mixture having a bromine content of 5%, a sulfur content of 0.5% and a phosphorus content of 1.0%. 80 parts by weight of such flame retardant resin composition, 15 parts by weight of N-(β-aminoethyl)-γ-aminopropyl-triethoxysilane, 5 parts by weight of methyltetrahydrophthalic anhydride, 0.5 part by weight of 2-ethyl-4-methylimidazole, 5 parts by weight of ethylene glycol diglycidyl ether and 2.5 parts by weight of a defoamer airex940 were used to prepare a pouring sealant H in accordance with a common method in the art. The performance test results thereof are shown in Table 3 as follows.

### Comparison Example 9

100 g (solid calculation) of a brominated bisphenol A type epoxy resin having a bromine content of 20% and an epoxy equivalent of 420 g/eq and satisfying the market circulation standard was used to replace the flame retardant resin composition in Example 12, and other raw materials of the pouring sealant and the contents thereof were the same as those in Example 12, to prepare a pouring sealant L. The performance test results thereof are shown in Table 3 as follows.

### Comparison Example 10

16.7 g (solid calculation) of a brominated bisphenol A type epoxy resin having a bromine content of 20% and an epoxy equivalent of 420 g/eq and 50 g of a liquid bisphenol A type epoxy resin having an epoxy equivalent 186 g/eq were mixed to obtain an epoxy resin composition having a bromine content of 5%, which was used to replace the flame retardant resin composition in Example 12. Other raw materials of the pouring sealant and the contents thereof were the same as those in Example 12, to prepare a pouring sealant M. The performance test results thereof are shown in Table 3 as follows.

### Comparison Example 11

27.6 g of a brominated bisphenol A type epoxy resin having a bromine content of 48.5% and an epoxy equivalent of 400 g/eq was added into 100 g of a liquid bisphenol A type epoxy resin having an epoxy equivalent 186 g/eq and mixed to obtain a flame retardant resin mixture having a bromine content of 10.5%, which was used to replace the flame retardant resin composition in Example 12. Other raw materials of the pouring sealant and the contents thereof were the same as those in Example 12, to prepare a pouring sealant N. The performance test results thereof are shown in Table 4 as follows.

### Comparison Example 12

30.4 g of p-benzenedithiol having a sulfur content of 45% was added into 100 g of a liquid bisphenol A type epoxy resin having an epoxy equivalent 186 g/eq and mixed to obtain a flame retardant resin mixture having a sulfur content of 10.5%, which was used to replace the flame retardant resin composition in Example 12. Other raw materials of the pouring sealant and the contents thereof were the same as those in Example 12, to prepare a pouring sealant O. The performance test results thereof are shown in Table 4 as follows.

### Comparison Example 13

29.3 g of a brominated bisphenol A type epoxy resin having a bromine content of 48.5% and an epoxy equivalent of 400 g/eq was added into 100 g of a liquid bisphenol A type epoxy resin having an epoxy equivalent 186 g/eq and mixed to obtain a flame retardant resin mixture having a bromine content of 11%, which was used to replace the flame retardant resin composition in Example 13. Other raw materials of the pouring sealant and the contents thereof were the same as those in Example 13, to prepare a pouring sealant P. The performance test results thereof are shown in Table 4 as follows.

### Comparison Example 14

122 g of DOPO-etherified bisphenol A having a phosphorus content of 10.0% and a phenolic hydroxyl equivalent of 300 g/eq was added into 100 g of a liquid bisphenol A type epoxy resin having an epoxy equivalent 186 g/eq and mixed to obtain a flame retardant resin mixture having a phosphorus content of 5.5%, which was used to replace the flame retardant resin composition in Example 14. Other raw materials of the pouring sealant and the contents thereof were the same as those in Example 14, to prepare a pouring sealant Q. The performance test results thereof are shown in Table 4 as follows.

### Comparison Example 15

15.7 g of p-benzenedithiol having a sulfur content of 45% and 12.8 g of tetra-(2,6-dimethylphenyl) resorcinol bisphosphonate having a phosphorus content of 10.0% were added into 100 g of a liquid bisphenol A type epoxy resin having an epoxy equivalent 186 g/eq and mixed to obtain a flame retardant resin mixture having a sulfur content of 5.5% and a phosphorus content of 1.0%, which was used to replace the flame retardant resin composition in Example 15. Other raw materials of the pouring sealant and the contents thereof were the same as those in Example 15, to prepare a pouring sealant R. The performance test results thereof are shown in Table 4 as follows.

### Comparison Example 16

2.86 g of p-benzenedithiol having a sulfur content of 45% and 154.5 g of tetra-(2,6-dimethylphenyl) resorcinol bisphosphonate having a phosphorus content of 10.0% were added into 100 g of a liquid bisphenol A type epoxy resin having an epoxy equivalent 186 g/eq and mixed to obtain a flame retardant resin mixture having a sulfur content of 0.5% and a phosphorus content of 6%, which was used to replace the flame retardant resin composition in Example 8. Other raw materials of the pouring sealant and the contents thereof were the same as those in Example 8, to prepare a pouring sealant S. The performance test results thereof are shown in Table 4 as follows.

TABLE 3

| | | | | | | Comparison | Comparison |
|---|---|---|---|---|---|---|---|
| | | Example 12 | Example 13 | Example 14 | Example 15 | Example 9 | Example 10 |
| | | Pouring | Pouring | Pouring | Pouring | Pouring | Pouring |
| Test items | Methods | sealant A | sealant D | sealant G | sealant H | sealant L | sealant M |
| Surface drying | GB/T13477 | 12 | 11 | 10 | 9 | 15 | 14 |
| time at 80° C. | | | | | | | |
| (min) | | | | | | | |
| viscosity | GB/T2794-1995 | 3000 | 3500 | 2700 | 2500 | 7400 | 7500 |
| (mPa · s) | | | | | | | |
| Heat | GB/T531-1999 | 1.2 | 1.25 | 1.30 | 1.36 | 0.81 | 0.75 |
| conductivity | | | | | | | |
| (w/m · K) | | | | | | | |
| Hardness | GB/T531-1999 | 45 | 40 | 42 | 40 | 60 | 62 |
| (Shore A) | | | | | | | |
| Stability | | better | better | better | better | General | General |
| Flame | UL -94 | V-0 | V-0 | V-0 | V-0 | V-0 | Complete |
| retardancy | | | | | | | combustion |

TABLE 4

| | | Comparison | Comparison | Comparison | Comparison | Comparison | Comparison |
|---|---|---|---|---|---|---|---|
| | | Example 11 | Example 12 | Example 13 | Example 14 | Example 15 | Example 16 |
| | | Pouring sealant | Pouring sealant | Pouring sealant | Pouring sealant | Pouring sealant | Pouring sealant |
| Test items | Methods | N | O | P | Q | R | S |
| Surface | GB/T13477 | 16 | 15 | 15 | 18 | 16 | 15 |
| drying time at | | | | | | | |
| 80° C. (min) | | | | | | | |
| viscosity | GB/T2794-1995 | 7500 | 7800 | 7000 | 6600 | 6500 | 6700 |
| (mPa · s) | | | | | | | |
| Heat | GB/T531-1999 | 0.77 | 0.81 | 0.63 | 0.67 | 0.92 | 0.85 |
| conductivity | | | | | | | |
| (w/m · K) | | | | | | | |
| Hardness | GB/T531-1999 | 69 | 73 | 65 | 60 | 68 | 65 |
| (Shore A) | | | | | | | |
| Stability | | General | General | General | General | General | General |
| Flame | UL -94 | Complete | Complete | Complete | Complete | Complete | Complete |
| retardancy | | combustion | combustion | combustion | combustion | combustion | combustion |

It can be seen from the test results in Tables 3 and 4 that, the pouring sealant prepared according to the present invention has a surface drying time of 9-12 min at 80° C., a viscosity of 2500-3500 mPa·s, a thermal conductivity of 1.2-1.36 w/m·K, a hardness of 40-45 A, a good stability and a flame retardancy of V-0 level.

By comparing Examples 12-15 with Comparison Examples 9-16, it can be seen that the bromine-containing flame retardant in the present invention can be used in combination with the sulfur-containing flame retardant and/or the phosphorus-containing flame retardant to compose a synergistic flame retardant. The present invention discloses applying a bromine-containing phenol compound and epoxy resins thereof as a bromine-containing flame retardant, in combination with a sulfur-containing flame retardant and/or a phosphorus-containing flame retardant and a halogen-free epoxy resin, to make the prepared pouring sealant have better comprehensive performances. The present invention can maintain the pouring sealant with a good flame retardancy, a moderate hardness, a lower viscosity, a good thermal conductivity and a good stability while reducing the bromine element content.

### Example 16

10 g of a brominated bisphenol A type epoxy resin, 5 g of p-benzenedithiol and 80 g of ABS resin, 3 g of N-2,6-dimethylphenylmaleimide type (TM-PMI) heat-resistant modifier and 1 g of antioxidant 1010 were homogeneously mixed in a high pressure homogenizer at 75° C. for 15 min, and then extruded in a twin screw extruder. The temperatures of each section of the twin screw extruder were 165° C. in a first zone, 180° C. in a second zone, 210° C. in a third zone, 240° C. in a fourth zone, 170° C. in a fifth zone. A ABS composite was obtained by granulation. The performance test results are shown in Table 5.

### Example 17

10 g of a brominated bisphenol A type epoxy resin, 1 g of tetra-(2,6-dimethylphenyl) resorcinol bisphosphonate, 84 g of ABS resin, 2 g of N-2,6-dimethylphenylmaleimide type (TM-PMI) heat-resistant modifier and 3 g of antioxidant 168 were homogeneously mixed in a high pressure homogenizer at 75° C. for 15 min, and then extruded in a twin screw extruder. The temperatures of each section of the twin screw extruder were 180° C. in a first zone, 190° C. in a second zone, 230° C. in a third zone, 240° C. in a fourth zone, 180° C. in a fifth zone. A ABS composite was obtained by granulation. The performance test results are shown in Table 5.

### Example 18

5 g of a brominated bisphenol A, 0.5 g of DOPO-etherified bisphenol A, 91.5 g of ABS resin, 1 g of N-2,6-dimethylphenylmaleimide type (TM-PMI) heat-resistant modifier and 2 g of antioxidant 1010 were homogeneously mixed in a high pressure homogenizer at 80° C. for 15 min, and then extruded in a twin screw extruder. The temperatures of each section of the twin screw extruder were 165° C. in a first zone, 180° C. in a second zone, 210° C. in a third zone, 240° C. in a fourth zone, 170° C. in a fifth zone. A ABS composite was obtained by granulation. The performance test results are shown in Table 5.

### Example 19

5 g of a brominated bisphenol A type epoxy resin, 5 g of p-benzenedithiol, 1 g of tetra-(2,6-dimethylphenyl) resorcinol bisphosphonate and 91.5 g of ABS resin, 1 g of N-2,6-dimethylphenylmaleimide type (TM-PMI) heat-resistant modifier and 1 g of antioxidant 168 were homogeneously mixed in a high pressure homogenizer at 70° C. for 10 min, and then extruded in a twin screw extruder. The temperatures of each section of the twin screw extruder were 170° C. in a first zone, 185° C. in a second zone, 220° C. in a third zone, 245° C. in a fourth zone, 180° C. in a fifth zone. A ABS composite was obtained by granulation. The performance test results are shown in Table 5.

### Comparison Example 17

This comparison Example was different from Example 1 only in adding no brominated bisphenol A type epoxy resin or p-benzenedithiol in the preparation of the ABS composite, and adding 95 g of ABS resin, 3 g of N-2,6-dimethylphenylmaleimide type (TM-PMI) heat-resistant modifier and 1 g of antioxidant 1010 to prepare and obtain a ABS composite by the same method as in Example 1. The performance test results are shown in Table 5.

### Comparison Example 18

This comparison Example was different from Example 1 only in adding no brominated bisphenol A type epoxy resin in the preparation of the ABS composite, and adding 13 g of p-benzenedithiol and other raw materials in the same amounts by the same method as in Example 1 to obtain a ABS composite. The performance test results are shown in Table 5.

### Comparison Example 19

This comparison Example was different from Example 1 only in adding no p-benzenedithiol in the preparation of the ABS composite, and adding 13 g of a brominated bisphenol A type epoxy resin and other raw materials in the same amounts by the same method as in Example 1 to obtain a ABS composite. The performance test results are shown in Table 6.

### Comparison Example 20

This comparison Example was different from Example 4 only in adding no brominated bisphenol A type epoxy resin or tetra-(2,6-dimethylphenyl) resorcinol bisphosphonate in the preparation of the ABS composite, and adding 95 g of ABS resin, 2 g of N-2,6-dimethylphenylmaleimide type (TM-PMI) heat-resistant modifier and 3 g of antioxidant 168 to prepare and obtain a ABS composite by the same method as in Example 4. The performance test results are shown in Table 6.

### Comparison Example 21

This comparison Example was different from Example 4 only in adding no brominated bisphenol A type epoxy resin in the preparation of the ABS composite, and adding 11 g of tetra-(2,6-dimethylphenyl) resorcinol bisphosphonate and other raw materials in the same amounts by the same method as in Example 4 to obtain a ABS composite. The performance test results are shown in Table 6.

### Comparison Example 22

This comparison Example was different from Example 4 only in adding no tetra-(2,6-dimethylphenyl) resorcinol bisphosphonate in the preparation of the ABS composite, and adding 11 g of a brominated bisphenol A type epoxy resin and other raw materials in the same amounts by the same method as in Example 4 to obtain a ABS composite. The performance test results are shown in Table 6.

### Comparison Example 23

This comparison Example was different from Example 8 only in adding no brominated bisphenol A type epoxy resin in the preparation of the ABS composite, and adding 5.5 g of p-benzenedithiol and other raw materials in the same amounts by the same method as in Example 8 to obtain a ABS composite. The performance test results are shown in Table 6.

### Comparison Example 24

This comparison Example was different from Example 8 only in adding no brominated bisphenol A type epoxy resin in the preparation of the ABS composite, and adding 6 g of tetra-(2,6-dimethylphenyl) resorcinol bisphosphonate and other raw materials in the same amounts by the same method as in Example 8 to obtain a ABS composite. The performance test results are shown in Table 6.

TABLE 5

| | Example | Example | Example | Example | Example | Example |
|---|---|---|---|---|---|---|
| Test items | 16 | 17 | 18 | 19 | 17 | 18 |
| Bending | 84 | 84 | 82 | 83 | 70 | 72 |
| strength | | | | | | |
| (MPa) | | | | | | |
| Tensile | 67 | 67.9 | 68.2 | 68.4 | 55 | 58 |
| strength | | | | | | |
| (MPa) | | | | | | |
| Notch | 28.1 | 28.7 | 29.2 | 29.5 | 20 | 22 |
| impact | | | | | | |
| strength | | | | | | |
| (J/m) | | | | | | |
| Heat | 130 | 136 | 131 | 134 | 115 | 120 |
| distortion | | | | | | |
| temperature | | | | | | |
| (1.82 MPa, | | | | | | |
| ° C.) | | | | | | |
| Melting index | 13.2 | 14.1 | 15 | 14.2 | 16.8 | 15.7 |
| (280° C., | | | | | | |
| 2.16 KG) | | | | | | |
| Oxygen index | 26.2 | 26.8 | 27.2 | 27.5 | 20 | 22 |
| (%, GB/T | | | | | | |
| 2406-2009) | | | | | | |

TABLE 6

| | Comparison | Comparison | Comparison | Comparison | Comparison | Comparison |
|---|---|---|---|---|---|---|
| Test items | Example 19 | Example 20 | Example 21 | Example 22 | Example 23 | Example 24 |
| Bending strength | 76 | 72 | 73 | 76 | 71 | 73 |
| (MPa) | | | | | | |
| Tensile strength | 62 | 54 | 56 | 60 | 57 | 56 |
| (MPa) | | | | | | |
| Notch impact | 24 | 23 | 25 | 24 | 24 | 25 |
| strength | | | | | | |
| (J/m) | | | | | | |
| Heat distortion | 118 | 113 | 122 | 121 | 119 | 124 |
| temperature | | | | | | |
| (1.82 MPa, ° C.) | | | | | | |
| Melting index | 15.5 | 16.9 | 16 | 15.8 | 16.1 | 16.4 |
| (280° C., | | | | | | |
| 2.16 KG) | | | | | | |
| Oxygen index | 23 | 21 | 23 | 23 | 22 | 23 |
| (%, GB/T | | | | | | |
| 2406-2009) | | | | | | |

It can be seen from the test results in Table 5 and Table 6 above that, the ABS composite prepared according to the present invention has a bending strength of as high as 82-84 MPa, a tensile strength of as high as 67-68.4 MPa, a notch impact strength of as high as 28.1-29.5 J/m, a heat distortion temperature of 130-136° C., a melting index of 13.2-15 and an oxygen index of 26.2-27.5% with good flame resistance, excellent mechanical properties and heat resistance.

By comparing Examples 16-19 with Comparison Examples 17-24, it can be found that the bromine-containing flame retardant, the sulfur-containing flame retardant and/or the phosphorus-containing flame retardant in the flame-retardant resin composition have a synergistic effect on the flame retardancy, can enhance the flame retardant property of the ABS composites, and make the flame-retardant ABS composite of the invention have good mechanical properties and heat resistance.

The present invention discloses in the embodiments only the examples that the flame-retardant ABS composite is used as the flame retardant engineering plastics. Due to the synergistic flame retardant effect of the composite flame retardant, other engineering plastics such as polystyrene plastic, polypropylene plastic, polyurethane, wire and cable materials and the like also have good flame resistance, excellent mechanical properties and heat resistance.

The applicant claims that the present invention illustrates the composite flame retardant, the flame retardant resin composition, the composite metal substrate, the flame retardant electronic material and the flame retardant engineering plastic of the present invention by the above embodiments. But the present invention is not limited to the above examples. That is to say, it does not means that the present invention shall be carried out with respect to the above-described embodiments. Those skilled in the art shall know that any improvements to the present invention, equivalent replacement of the raw materials of the present invention, addition of auxiliary ingredients, selection of specific ways and the like all fall within the protection scope and disclosure scope of the present invention.

1. A composite flame retardant, wherein the composite flame retardant comprises a bromine-containing flame retardant, a sulfur-containing flame retardant and/or a phosphorus-containing flame retardant, wherein the bromine-containing flame retardant is a bromine-containing phenol compound and epoxy resins thereof.

2. A flame retardant resin composition, wherein the flame retardant resin composition comprises the composite flame retardant claimed in claim 1 and a halogen-free epoxy resin.

3. The flame retardant resin composition according to claim 2, wherein the bromine element is in an amount of 10 wt. % or less of the flame retardant resin composition.

4. The flame retardant resin composition according to claim 2, wherein the sulfur element is in an amount of 0.2 wt. % or more of the flame retardant resin composition.

5. The flame retardant resin composition according to claim 2, wherein the phosphorus element is in an amount of 0.2 wt. % or more of the flame retardant resin composition.

6. The flame retardant resin composition according to claim 2, wherein the bromine-containing flame retardant is anyone selected from the group consisting of brominated phenolic resin, brominated phenolic epoxy resin, brominated bisphenol A, brominated bisphenol A derivative, brominated bisphenol A type epoxy resin, tetrabromobisphenol S, tetrabromobisphenol allyl ether, tribromophenol and pentabromophenol, or a combination of at least two selected therefrom.

7. The flame retardant resin composition according to claim 2, wherein the sulfur-containing flame retardant is p-benzenedithiol and/or 4,4′-diaminodiphenyl disulfide.

8. The flame retardant resin composition according to claim 2, wherein the phosphorus-containing flame retardant is anyone selected from the group consisting of DOPO etherified bisphenol A, DOPO-modified epoxy resin, tri-(2,6-dimethylphenyl)phosphine, tetra-(2,6-dimethylphenyl)resorcinol bisphosphonate, resorcinol tetraphenyl diphosphate, triphenyl phosphate, bisphenol A bis-(diphenyl phosphate), phosphonitrile flame retardant, 10-(2,5-dihydroxyphenyl)-10-hydro-9-oxa-10-phosphaphenanthrene-10-oxide, 10-(2,5-dihydroxynaphthyl)-10-hydro-9-oxa-0-phosphaphenanthrene-0-oxide and 9,10-dihydro-9-oxa-10-phosphaphenanthrene-10-oxide, or a mixture of at least two selected therefrom.

9. The flame retardant resin composition according to claim 2, wherein the flame retardant resin composition comprises other flame retardant materials.

10. The flame retardant resin composition according to claim 9, wherein the other flame retardant material is anyone selected from the group consisting of organosilicone flame retardant, chlorine-containing organic flame retardant, nitrogen-containing organic flame retardant and inorganic flame retardant, or a combination of at least two selected therefrom.

11. The flame retardant resin composition according to claim 10, wherein the chlorine-containing organic flame retardant is anyone selected from the group consisting of dioctyl tetrachlorophthalate, chlorendic anhydride, chlorendic acid and tetrachlorobisphenol A, or a combination of at least two selected therefrom.

12. The flame retardant resin composition according to claim 10, wherein the nitrogen-containing organic flame retardant is anyone selected from the group consisting of dicyandiamide, biurea and melamine, or a combination of at least two selected therefrom.

13. The flame retardant resin composition according to claim 10, wherein the inorganic flame retardant is anyone selected from the group consisting of aluminum hydroxide, magnesium hydroxide, antimony trioxide and zinc borate, or a combination of at least two selected therefrom.

14. The flame retardant resin composition according to claim 2, wherein the halogen-free epoxy resin is anyone selected from the group consisting of bisphenol A type epoxy resin, bisphenol F type epoxy resin, phenol type novolac epoxy resin, bisphenol A type novolac epoxy resin, o-cresol novolac epoxy resin, dicyclopentadiene type epoxy resin, isocyanate type epoxy resin and biphenyl type epoxy resin, or a combination of at least two selected therefrom.

15. The flame retardant resin composition according to claim 2, wherein the halogen-free epoxy resin is in an amount of 70-90 wt. % in the flame retardant resin composition.

16. A flame retardant electronic material, wherein the flame retardant electronic material comprises the flame retardant resin composition claimed in claim 2.

17. The flame retardant electronic material according to claim 16, wherein the flame-retardant electronic material comprises 60-80 parts by weight of the flame-retardant resin composition claimed in claim 2, 10-20 parts by weight of an organosilicone filler, 2 5 parts by weight of a curing agent, 0.5-2 parts by weight of a curing accelerator, 2-6 parts by weight of a diluent and 1-3 parts by weight of a defoamer.

18. The flame retardant electronic material according to claim 17, wherein the organosilicone filler is N-(β-aminoethyl)-γ-aminopropyl-triethoxysilane and/or glycidoxypropyltrimethoxysilane.

19. The flame retardant electronic material according to claim 17, wherein the curing agent is anyone selected from the group consisting of 4,4-diaminodiphenyl ether, 4,4-diaminodiphenyl sulfone, methyltetrahydrophthalic anhydride and methylhexahydrophthalic anhydride, or a combination of at least two selected therefrom.

20. The flame retardant electronic material according to claim 17, wherein the curing accelerator is anyone selected from the group consisting of 2-methylimidazole, resorcinol, dimethylbenzylamine and 2-ethyl-4-methylimidazole, or a combination of at least two selected therefrom.

21. The flame retardant electronic material according to claim 17, wherein the diluent is anyone selected from the group consisting of 1,4-butanediol diglycidyl ether, ethylene glycol diglycidyl ether, resorcinol diglycidyl ether and 1,6-hexanediol diglycidyl ether, or a combination of at least two selected therefrom.
